(19) United States
(12) Patent Application Publication
(10) Pub. No.: US 2024/0378983 A1
(43) Pub. Date: Nov. 14, 2024

(54) SYSTEMS AND METHODS FOR LEAK DETECTION WHICH UTILIZE OCCUPANCY INFORMATION

(71) Applicant: Ivani, LLC, Chesterfield, MO (US)

(72) Inventors: Matthew Wootton, Bridgeton, MO (US); Boris Dieseldorff, Des Peres, MO (US); Justin McKinney, Foristell, MO (US); Matthew Rush, St. Charles, MO (US); Saarth Mehrotra, Appleton, WI (US); Scott Kennedy, Manchester, MO (US); Travis Dierks, Foristell, MO (US)

(21) Appl. No.: 18/662,745

(22) Filed: May 13, 2024

Related U.S. Application Data
(60) Provisional application No. 63/466,235, filed on May 12, 2023.

(51) Int. Cl. G08B 21/20; G08B 21/22

(52) U.S. Cl. CPC G08B 21/20; G08B 21/22

(57) ABSTRACT

Systems and methods which allow for the integration of occupancy detection with traditional leak detection systems to further enhance the detection of dangerous leaks and allow them to be responded to in a more effective manner. The occupancy system will typically be integrated with flow detection systems, however, water presence detectors can also be integrated in another embodiment.

### CROSS REFERENCE TO RELATED APPLICATION(S)

This application claims the benefit of U.S. Provisional Patent Application Ser. No. 63/466,235, filed May 12, 2023, the entire disclosure of which is herein incorporated by reference.

### BACKGROUND OF THE INVENTION

### Field of the Invention

This disclosure is related to the field of detection or security, and more particularly to systems and methods where occupancy information can be paired with traditional leak detection to better determine the likely risk of a water or other fluid leak in a structure.

### Description of the Related Art

While water access within a dwelling such as a home, apartment, or even a business such as a factory or office, is considered a near necessity in the modern world to provide drinking water as well as to service sewage systems and water using appliances such as dishwashers and laundry machines, water within a dwelling can also be a major danger. Water is very destructive to most traditional building materials such as wood and gypsum (drywall) and water which gets loose in a dwelling can quickly cause thousands of dollars in damage as it is absorbed by these building materials. Loose water in a dwelling may also cause electrical short circuits resulting in a serious risk of personal injury or fire. Depending on its source and nature, loose water in a dwelling can also be a source of infectious agents or poisonous chemicals (for example, in the form of mold) which can cause further damage and also require expensive remediation for future safety.

Because of concerns around the destructiveness of water, water is typically both restrained outside a dwelling and constrained within a dwelling. Specifically, with regards to environmental water (e.g. rainfall), dwellings are typically built with external materials that withstand and repel environmental water to keep it outside. With regards to water used within a dwelling, the water is typically constrained within piping systems and used in locations and systems (e.g. appliances, basins, and the like) that are built to be essentially impervious to water. The danger, however, is often failure within the transport systems of water to these items (piping), the water using systems' interconnection to this piping, or internal valves and structures within the systems. Because of these potential weaknesses, piping systems often include multiple valves to shut off water to specific locations in the event that any of these items are damaged or leaking.

Water, in conjunction with oxygen, however, is quite corrosive and over time piping, connections, valves, and appliances can slowly fail and begin to leak water. This is, sadly, a normal course of affairs and virtually every home and business owner has had to deal with water leaks at some time. Broken faucets, corroded pipes, and damaged basins can all leak water and need to be replaced. Further, mechanical systems within the water path will all wear over time and eventually shut-off valves and the like also require replacement. Even outside of specific failures, the need of human occupants to access and use water resources can also create water dangers. Leaving a bathtub running to overflowing or backing up a toilet can also lead to water damage.

Water damage is incredibly common and more homes suffer water damage than fire or theft. Much water damage, however, is relatively contained. Many rooms which are designed to have water available in them also include some secondary control systems to help constrain it. For example, a leaky shower will often lose water, but it will typically go into the shower stall itself and onto a surface designed to repel water and direct it safely down a drain. Further, laundry rooms, bathrooms, and kitchens are often tiled or have other floor coverings which are designed to repel water and may include special emergency drains or containment basins in the event of a water leak.

These types of protections often make water leaks at appliances or other end user locations (e.g. faucets) relatively easy to handle and help mitigate damage. For example, faucets almost always include easily accessible water shut-off valves which can stop water flow to a faulty faucet while still maintaining water access elsewhere in the dwelling. These allow for fairly straight-forward water shut-off procedures in the event of an appliance or faucet failure, or even to simply allow for such devices to be routinely replaced without the need to shut-off the water to the dwelling more generally.

Many leaks, therefore, present a real, but relatively small and confined, danger. One major danger, however, is from the risk of broken pipes or failure of more structural plumbing elements compared to end user appliances or objects. In the first instance, as opposed to a leaky faucet or dishwasher, a pipe break may not be immediately visible or detectable until the water has already done relatively major damage (e.g. is now soaking through a wall or pooling on a floor) which is what makes the leak detectable. Further, a pipe break will often result in a relatively fast flow of water and can cause damage quickly. When a faucet or valve fails, it often does so slowly, with a failing valve, for example, creating a steady and easy to constrain drip that only slowly becomes something greater. This can allow time to repair the systems and to institute relatively straightforward emergency remediation (e.g. putting a bucket under the valve).

However, pipes can break suddenly and a concern is that water may be supplied from the water main to flow through the broken pipe until the water is manually turned off at a valve upstream. In most municipal dwellings, the last line of defense is often the main valve which connects the dwelling to the municipal water source. The systems for such shutoffs are typically rarely used and not necessarily easily accessible because they are not commonly needed, so a single damaged pipe can result in much more water damage than any form of overflowing basin or failed faucet valve where there may be remediation devices in place already.

This risk of danger is combined with the relatively high likelihood that pipe breaks can occur under certain circumstances. Poor plumbing construction and extreme weather can lead to pipes freezing and rupturing, and such occurrences are relatively commonplace during the depths of winter. Even with good construction techniques, pipes can still be damaged by external sources such as animal activity and will typically also start to slowly leak over time due to corrosion issues. These small leaks can lead to increased corrosion of the pipe around the leak which can give way spectacularly even without extreme or unexpected cold. Again, in pipes the risk is often heightened because the initial failure may not be visible to an occupant of the dwelling as it may occur in a wall, floor, or typically unoccupied space.

Because water damage is both relatively common, and can be highly destructive, there have been developed a number of systems to attempt to first inhibit water leaks from occurring and to detect water leaks when they do occur. A simple inhibition system is allowing a faucet to drip during extreme cold to help prevent pipes from freezing. More advanced systems can detect leaks (such as through unexpected flow or from water pooling where it is not expected). These can then raise alarms to occupants or automatically shutdown the water within a residence to avoid damage. Most leak detection devices typically operate on one of two principles. They either detect water where it isn't normally expected, or they detect flow and analyze it. A key elements of both systems is that they are looking for anomalies. That is, they are looking for water to be at, or to be moving toward, somewhere where it is not currently expected.

The first type of detectors are designed to trigger when water is detected in an irregular location and, therefore, a leak of some kind which is supplying water to that location is indicated. The advantage of these types of systems is that they detect the presence of the water where not expected and, therefore, are not dependent on detecting a leak versus normal use. The very presence of the water is not normal use. This means that these types of systems are independent of the cause of the water presence and can be used to detect environmental concerns (e.g. flooding caused by rainfall) as well as internal failures (e.g. pipe leaks).

They are, however, typically positioned near potential leak sources to detect leaks from them quicker. For example, water using appliances such as a clothes washing machine or water heater will often include an emergency overflow collection pan. As these devices often fill with a relatively large amount of water (many gallons), should they fail, the amount of water released can be a major issue. Thus, these pans are designed to mitigate the damage. However, as discussed above, many water bearing systems fail slowly and a small leak into an emergency pan may not be detected. However, should a water detection system be added to the pan, it can trigger from an initial leak, before a more major issue can occur.

These systems' positioning, however, is also their weakness. If systems are positioned generally (e.g. to detect water in a basement from any source), these systems don't know the source of the water, and even if they have the ability to shut off a water source, there is a chance that they will not actually shut off what is actually causing the water's presence. For example, a wet basement floor could be caused by a sewer backup, rainfall permeating a wall or floor, or a broken pipe. While the system would detect water from any of the three, it can only stop the last one, and then only if it is from a pipe in which it has the ability to shut off flow and only if the detector is located at or near the source. Thus, to be most accurate, a single dwelling often needs many such detectors to detect water in a variety of areas and potentially shut off flow to specific systems to which they are associated as indicated above. However, including multiple systems can be expensive and cumbersome and can also lead to various false alarms.

The second type of system detects unexpected flow of water within pipes. To try and detect leaks, these water leak detection systems do not detect that the water is where it is unexpected, they recognize that flow is occurring through a pipe which means that water may be going somewhere unexpected. These systems are then forced to guess when water flow is caused by a leak as opposed to when it is intended by an occupant of a dwelling as both can cause similar flow.

Water usage within a residence is common, and can vary over time. For example, a water leak detector that relied simply on the level of flow in a time period, or a fixed level of use over time, could readily shutoff water in the perfectly safe situation of a user filling up a bathtub, taking a long shower, or even watering plants, simply because the amount or rate of flow is unexpected compared to prior flow determinations. To deal with this, current leak detection systems primarily attempt to learn water usage patterns of occupants and then look for anomalies to this usage pattern which could indicate a leak. Typically, they are looking for flow at a higher level than expected, at a different time than expected, or both.

While this is better than simply looking at overall or instant flow, it is still very limited and highly inaccurate. The systems typically use only the information available directly from water flow sensors as part of the water monitoring system in a dwelling. Often, these are single device sensing systems at the water main and only know the total amount of flow into the dwelling. They don't know what it is being used for at any time. As such, they often require a great deal of training to model the usage patterns of the dwelling even remotely accurately and, even then, they can regularly come to inaccurate conclusions based on irregularity in patterns of usage by the occupants, or by a particular anomalous usage episode.

Thus, a significant challenge for current leak detection is to interconnect a detection of source (e.g. flow) with a determination of non-intended use (e.g. reason). The lack of a true evaluation of the second variable means that many systems have difficulty trying to differentiate normal vs. non-normal water usage. An uncommon water usage situation, for example someone who irregularly uses a large whirlpool tub, can easily result in a difficult-to-train scenario and false positives if the system is too sensitive and false negatives if it is not. The creation of such false outcomes can result in the systems being ineffective at their purpose (false negatives) or with them being cumbersome to use because they hinder intended water use (false positives). A proliferation of either type of error can readily result in systems being uninstalled or no longer used.

While usage patterns within a dwelling are useful, the real problems with flow systems in particular, and all these systems in general, is attempting to simply utilize a single variable where multiple are actually in play. Specifically, measuring usage patterns and then comparing unknown future patterns against them to look for usage has a problem of not knowing if usage is intended. Flow-detecting systems would work better if they not only detect unexpected usage (flow), but also determine that such flow was clearly not intended because no occupant was available to be using the water. One way to evaluate the intentionality of usage would be to determine if usage could be intended at all.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein are systems and methods which allow for the integration of occupancy detection with traditional leak detection systems to further enhance the detection of dangerous leaks and allow them to be responded to in a more effective manner. The occupancy system will typically be integrated with flow detection systems, however, water presence detectors can also be integrated in another embodiment.

There is described herein, in an embodiment, systems and methods of inhibiting damage from fluid leaks and particularly water leaks in a structure, the systems and methods comprising: providing a flow detection system which detects fluid flow into a at least a portion of the structure; providing an occupancy detection system which detects that if said portion of said structure is occupied or not; detecting a fluid flow in the portion of the structure; determining if said fluid flow corresponds to an amount which is anomalous for that portion at a current time; determining if said portion of the structure is currently occupied; and if said portion of said structure is currently occupied, initiating a first level of alarm; and if said portion of said structure is currently unoccupied, initiating a second level of alarm different from said first level or alarm.

In an embodiment of the method, the fluid is water.

In an embodiment of the method, the first level of alarm comprises monitoring said amount of flow for further anomalies.

In an embodiment of the method, the second level of alarm comprises an indicator to occupants of said structure.

In an embodiment of the method, the second level of alarm comprises notifying a mobile device of said second level of alarm.

In an embodiment of the method, the second level of alarm comprises said flow detection system shutting off fluid to said portion.

In an embodiment of the method, the first level of alarm comprises an indicator to occupants of said structure and the second level of alarm comprises notifying a mobile device of said second level of alarm and/or the flow detection system shutting off fluid to said portion.

In an embodiment of the method, the portion of said structure comprises a specific room in said structure.

In an embodiment of the method, the at least a portion of said structure comprises the entirety of said structure.

In an embodiment of the method, the detecting requires a level of flow above a predetermined threshold.

In an embodiment of the method, the occupancy detection utilizes Network Presence Sensing (NPS) detection.

In an embodiment of the method, the occupancy detection system detects and tracks a specific occupant within said structure.

In an embodiment of the method, the occupancy detection system counts a number of occupants within said structure.

In an embodiment of the method, the number of occupants is used to determine if the flow is anomalous.

In an embodiment of the method, the occupancy detection system segregates human occupants from non-human occupants within said structure.

In an embodiment of the method, the flow detection system utilizes machine learning in determining if said fluid flow corresponds to said amount which is anomalous for that portion at said current time.

In an embodiment of the method, machine learning is utilized in determining said first level of alarm and said second level of alarm after each anomalous fluid flow detection.

In an embodiment of the method, the flow detection system communicates with an automated water using system in determining if said flow corresponds to said amount which is anomalous for that portion at said current time.

### BRIEF DESCRIPTION OF THE DRAWINGS

FIG. 1 depicts a flow chart of an embodiment of a method according to the present disclosure.

### DETAILED DESCRIPTION OF THE PREFERRED EMBODIMENT(S)

Occupancy of a dwelling would be a useful piece of information which can significantly enhance a water flow measurement system when it comes to being able to determine whether flow is intended or not. For purposes of this disclosure, “occupancy” of a dwelling includes, but is not limited to, the current occupancy of an overall dwelling or interconnected dwellings, the current occupancy of a specific area within a dwelling or a portion of a dwelling (e.g. a specific room, or a specific set of rooms), a historical set of occupancy data of the overall dwelling, and/or a historical set of occupancy data of a specific area or areas of an overall dwelling. It can also help detect a potential for increased leak severity as lack of an occupant who can utilize already existing shutoff systems creates greater risk than if an occupant initiated shutoff is possible. Without occupancy information, current leak detection systems are reliant on constructing and maintaining models of human water usage patterns over time, including untangling a mess of overlapping information, especially as it pertains to dwellings with multiple users. With such information, a determination of the possibility of an occupant to be behaving in the anomalous manner provides a new threshold determination and allows for much of the noise due to anomalous human behavior to be removed from the system.

The inclusion of occupancy data as information on top of water usage patterns in a dwelling can significantly aid in the detection and management of leaks because it can determine if a specific flow could be caused by an occupant at all. When looking at detecting leaks, information about the occupancy of the home can significantly improve the simplicity and accuracy with which leaks versus anomalous, but desired, use may be detected. At a base level, any water flowing through a dwelling during a time when there is no occupancy detected in the home is typically a greater cause for concern than when the dwelling is occupied.

While there are absolutely times when water may be flowing with nobody in a dwelling (for example, because of an ice machine or sprinkler system running according to an automated pattern or from a person turning on a dishwasher and then leaving), usage when there is no occupancy often follows much clearer and well-defined rules because it is typically performed by automated systems. Some automated systems or patterns are capable of reporting their use to a central system wherein the reported system usage can be used as an additional input on top of occupancy information to further enhance system functionality. Further, should a potential leak be detected when there is no occupancy, automated shut-down procedures are often more effective and less intrusive.

With regards to expected usage during non-occupancy, a simple example is an automated sprinkler system which will often create flow without an occupant initiating the flow. However, this will typically occur in a specific preprogrammed pattern which is the epitome of regular usage and is easily determined to be expected flow in a usage learning system. Further, such systems are typically digitally automated and the automation system which drives the usage can also interface with a leak detector system to specifically indicate that the sprinkler activation is intended usage and not a leak. For example, when the sprinkler system is not based on timing but is driven by an environmental sensor, this information can also be provided to the leak detector (or simply understood to be part of the reasoning for the flow based on information from the automated system). This allows for a fairly easy and robust detection of expected usage by such systems when there is no occupancy.

Outside of such easily identifiable automated usage, a simple approach which can improve leak detection is for some form of alert to be generated anytime there's an absent dwelling and water, or any other fluid, is moving toward a point of use. This improvement could significantly simplify the approach to detecting leaks in a dwelling and provide for better response. Further, a leak which occurs when a dwelling is occupied is also far more likely to be detected quickly by a human user and they can be shut off the water without the need for automated alerts and responses. The most dangerous leaks, however, often occur when the dwelling is unoccupied as even if the leak is detected quickly, there may be no one around to shut off the water resulting in escalating damage over time. Thus, a leak detection system which provides for both detection alert and ability to shut-off water supplies while the occupant is at a remote location can be highly beneficial.

As contemplated herein, occupancy data may take many different forms. It may include, but is not limited to motion data, information from a wireless network sensing system (such as, but not limited to, the types of systems described in U.S. Pat. No. 9,474,042, the entire disclosure of which is herein incorporated by reference), camera identification of people, presence of people indicated by presence of their wireless device, interactions with devices in a dwelling, and/or arming/disarming of a security system. Occupancy determination may be in the form of direct sensing (e.g. motion sensing), through indirect sensing (e.g. through activation of doors or other points of ingress or egress), or through predictive systems such as via machine learning. The incorporation of such data provides significant additional information on top of water usage information from one or more water usage or leak/moisture sensors in the dwelling in question.

Similarly water usage within a dwelling may be measured at one or multiple points, depending on the system employed, and may produce a time series of water volume consumed through one or multiple points in the system. Traditionally, water usage determinations have been done at only a single point in the system for the sake of simplicity. Typically, this is at the level of water entering the location from the main. Further, water use measurement systems can either be purely measurement based or may additionally include a shutoff mechanism capable of acting in the event of a leak. The data produced by a system such as this is currently only used on its own to try and ascertain whether there exists a leak in the dwelling by detecting anomalous increased flow into the building. Such leak detection systems rely on the system understanding the water usage on its own, which is ineffective.

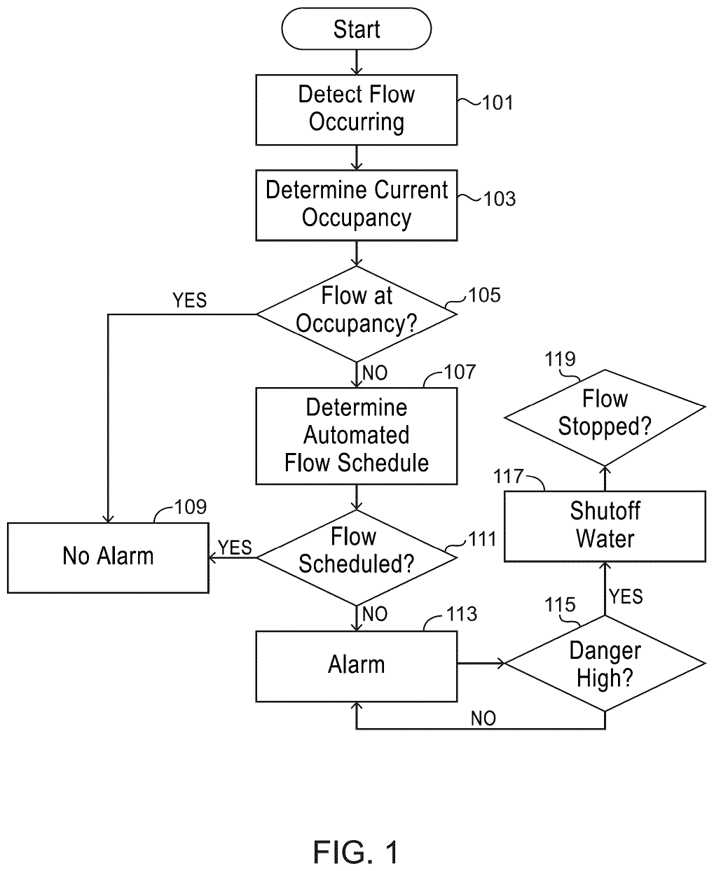

FIG. 1 provides for a flowchart of an embodiment of a water leak detection methodology which utilizes occupancy detection. This embodiment is by no means exhaustive, but is useful in illustrating one manner of operation of a system that may detect both flow and occupancy. Further, the methodology may be incorporated into any system or means that can carry out the various steps including, but not limited to, the systems and means contemplated herein. The methodology begins with an initial detection of flow (101) by a standard flow detector. Generally, the flow will be detected into the building as a whole, but this is by no means required and more granular detection may be provided. The detection of some flow effectively starts an internal alert in the system that something may be happening which requires review. As such, any flow may start the evaluation. Alternatively, the evaluation may only begin once the flow has reached a certain volume over time or flow rate. Once the concerning flow is detected, the next step will typically be to determine if there is occupancy at the point of flow (103). As discussed in greater detail below, this determination may be at different levels of granularity as desired in the specific embodiment.

If there is occupancy at or near the destination of the flow (e.g. a person is in the bathroom which currently has water flowing toward it) (105), the system will typically treat this as an intended use and not activate an alarm (109). The system may also evaluate occupancy near the point of flow. For example, if flow to a bathroom is detected, but the bathroom is empty, the system may determine if there is an occupant nearby (e.g. in a neighboring room). This can allow for certain behavior around how water is used and the system may be predictive based on machine learning or other systems which model expected occupant behavior. As simple example is if a user typically leaves a room while filling a bathtub to undress, this expected movement can be detected and evaluated as expected behavior around the flow. Similarly, a user may start a dishwasher and then leave the dwelling. In this case, the timing and behavior could follow an expected pattern which can be detected as related to standard occupant behavior. For example, if the usage occurs at a similar time of day to other known expect uses and follows a similar pattern.

However, if there is no occupancy or expected behavior around occupancy and continued flow of water for some time thereafter, the system will proceed to determine if there is an automated system (107) that would be expected to be causing such a flow. For example, the system may query an automated sprinkler system if it is currently running or may consult a provided database of expected usage or a machine learning model of expected usage determined from prior behavior during non-occupancy. If these would lead the system to believe that the flow is scheduled or intended (111), typically the system will again enter a no-alarm state (109). Should this be indicated in the negative, the system has now identified an unexpected flow toward a destination which is not currently and/or recently occupied. This will typically trigger an initial alarm state (113). It should be recognized that while in FIG. 1 the detection of occupancy (105) occurs before the automated state evaluation (107) but this is by ne means necessary and these elements may occur in any order including being interspersed with them effectively being performed together.

The initial alarm state (113) need not necessarily be a shutoff event and typically will not be. Instead, the initial alarm state (113) may be an indicator to initiate a warning to an occupant. This may comprise any form of alarm or warning but, depending on embodiment, may be audio or visual alarms in the dwelling to notify any occupants present of the situation. It may also comprise the leak detection system sending a warning to a mobile device of the occupant or a designated contact (for example, a friend, neighbor or landlord) indicating the warning situation and possibly requesting further instructions. Other monitoring services such as intrusion or fire monitoring services could also or alternatively be notified. Other types of alarm states may additionally or alternatively be used. These types of alarm states may be provided in an ascending manner whereby simple alarms, for example inside the dwelling, may be initiated and other alarms, for example notification of a mobile device, are only carried out if the flow state continues for a specified period of time after the initial alarm.

In the event that the alarm is deemed sufficiently concerning (115) the system may take further steps. In an embodiment, this further escalation may be because no occupants respond to any of the initial alarm states (113) in a prescribed time. Alternatively, escalation may occur if the flow is sufficiently great to present a major concern if it is a leak, or if other factors (for example environmental temperature) would indicate that it is more likely that this could be a leak situation. If the danger is sufficiently high, the system may proceed to shut-off a water source (117) to which the leak detector is connected. This could be a specific system to which it is connected (e.g. to a dishwasher only) up to the entire dwelling.

After water has been shut-off, the system may continue to monitor for flow to see if the flow has stopped (119). It would typically be expected that it would have stopped since that is the point of the shutdown event. However, should the flow still be detected, the system may evaluate if the leak detection could have been a fault detection (e.g. a false positive detection) or if the leak could be of very high level of concern (e.g. occurring at multiple places) or has occurred in conjunction with a failure of the shut-off system associated with that point of failure. As an example, a pipe break may have occurred in a point upstream of the valve to shut-off that pipe and, therefore, even with the valve activated, the flow continues. Should such a failure to mitigate be detected, the system can engage in additional warning and/or remediation steps. This could include, for example shutting off water at a more upstream point or notifying additional individuals of the situation.

In the contemplated embodiments such as that of FIG. 1, both occupancy data and water use (flow) data may be provided at any level of detail and granularity. Often, the systems will provide only a coarse granularity to allow for the system to utilize fewer components and to be less expensive and easier to install. For example, occupancy can be simply presented as whether it appears that a dwelling is occupied at all, or whether it is completely empty. At this level of granularity, a person being in the dwelling may be assumed to be causing the flow regardless of where they are or what they may be doing.

One example of such a low granularity system could be if an intrusion alarm has been previously armed. If the system is not armed, it is presumed that the dwelling is occupied and it does not matter where the occupant is in the dwelling. This can then be combined with water flow detection at a single reference point, which would typically be the primary source into the residence (at the main). If the intrusion system is armed, the dwelling is considered unoccupied and any flow could be considered anomalous. This simple presence determination could also be combined with prior usage patterns to locate what would be considered anomalous flow.

While it lacks any real detail, this first level of granularity is still quite valuable as a completely unoccupied residence should have no water usage except that which would correspond to automated systems or systems which would be known to be commonly left on when a user departs. These types of usage can often be relatively clearly defined and compared using standard learning models or even databases. For example, usage by automated systems such as an ice machine or sprinkler system are typically within certain bounds of water flow and timing and any detection of flow outside those various different bounds when the residence is unoccupied can trigger an alert situation. Such automated systems may also communicate with the flow detection system directly. Further, any level of flow when the dwelling is occupied may be ignored if the user is expected to be using it or able to react to it quickly. Such a system can also be useful as a monitor for people away from their dwelling without concern that it will interfere with their water usage when they are present.

While occupancy data and water flow can be useful at various granularities in space, they can also be useful at various granularities in time. For example, the parameters of a leak-detection system could be adjusted if the residence has been unoccupied for a number of days. Thus, in an embodiment, a long empty structure could have water shutoff immediately after flow was detected. Similarly, if the water flow aggregated over a time period (e.g. 24 hours) has changed dramatically compared to previous time periods but the occupancy has not changed dramatically, then it could trigger an alert situation. These types of coarse granularity can have advantages in terms of simplicity and accuracy.

While the above example of simply looking at an empty dwelling vs an occupied dwelling as a means of detecting potential leaks is illustrative, it is by no means exhaustive with regards to methods for combining the two data sources as each data source can be made more granular to better improve both detection of actual leak events and avoid detection of authorized usage as a leak event. For example, improvement of granularity in water flow detection can not only provide measurements of total flow over time, but where the flow is occurring within the residence as well. It should be recognized that water flow will typically be detected at a point upstream of where the water is leaving a pipe (intentionally or not). Thus, positioning and number of flow sensors relative to the piping system will often determine the level of granularity which can be obtained. The flow determination can also be both a detection that flow is occurring and can take into account the volume of flow. In this latter situation, a large flow in a room where devices are only intended to produce small flows can be a trigger even if the room is occupied. Similarly, a long unimpeded flow in a pipe where only short bursts are to be expected to occur can also trigger an alarm situation.

It should be recognized that detection of abnormalities in flow can occur both via trained usage data, but also via expected physical constraints. For example, a toilet flushing action is typically limited to about three gallons of total water. However, use of toilet facilities is often not temporally regular (especially if there are multiple facilities and multiple users who are in the dwelling a lot). However, if flow along a specific pipe which leads to a toilet can be detected, regardless of when it occurs (or if it occurs in accordance with an expected pattern or not) a flow of 4 or more gallons of water to a toilet without a break (even if over a relatively long window of time) could indicate a potential leak as this level of water use would be uncommon at any single toilet as multiple different users will typically still impart a small break in flow as would even a single user needing to flush multiple times in a row.

Occupancy data may also be better refined. In an embodiment, occupancy may not be for the entire residence, but may be for individual areas or rooms. Thus, water flow in an area where there is no occupancy, even if there is occupancy elsewhere in the dwelling, can also result in an alarm situation. To return to the toilet example above, flow to a toilet where there is no one within the bathroom can imply a potential leak situation.

The two may also be combined to further improve system robustness. Again, returning to the toilet example, a sudden flow starting at a toilet (and being of no more than 3 gallons) would be expected when the room was occupied. However, such a sudden commencement of flow when the room is not occupied can be a strong indicator of a dangerous leak situation and could result in the system not only issuing an alert but actually automatically shutting down water flow to that area. At the same time, a relatively slow but long flow at the same toilet regardless of if the room is occupied is less likely to indicate an immediate danger situation, but more likely to indicate that a flapper or valve in the toilet is sufficiently worn to need replacing and is resulting in a small, but contained, leak which should still be fixed to avoid it getting worse or wasting water. This situation can be provided as a specific form of alert suggesting that maintenance would be desirable

Generally, the systems and methods contemplated herein integrate occupancy data alongside water usage data to better predict leaks and other anomalies in water usage. When looking at various machine learning techniques, the inclusion of occupancy data can also allow the models to adjust parameters specifically during times when there are no occupants present to better incorporate the major differences in water usage common when a residence is occupied versus not. This adjustment can significantly increase the probability and/or speed of detection for leaks in a dwelling, allowing the overall leak detection system to significantly outperform the current state of the art systems through the added inclusion of occupancy data.

Occupancy data can even be further refined through the use of tracking or counting data as part of the occupancy information. Tracking occupants may be done using a number of techniques. Methods include, for example, attaching a moving transceiver to the occupant. Examples of such systems include global positioning location systems such as GPS, which use orbiting satellites to communicate with terrestrial transceivers. However, such systems are generally less effective indoors, where satellite signals may be blocked, reducing accuracy. Thus, other technologies are often used indoors, such as Bluetooth™ beacons, which calculate the location of a roaming or unknown transceiver. The roaming transceiver acts as a fiducial element. Such fiducial elements may not be useful in every tracking case, however. For example, the use of fiducial elements typically requires an upfront cost in procuring the necessary equipment. Further, the use of fiducial elements may require increased overhead as their use often must be planned or otherwise managed. For example, fiducial elements must be given to or otherwise attached to persons being tracked before those persons may be tracked by a fiducial element based tracking system. Moreover, tracking may not be possible or actively incorrect if a person does not carry the fiducial element, whether intentional or unintentional.

Other solutions for tracking persons through a space are known. For example, there exist detection methods and systems that may detect that there is a presence in a defined space (e.g., a room of a building) that is determined to be a human (or a particular human) by generally sensing disturbances to radio waves as they pass between two or more communicating network devices. These detection systems may be referred to in various places as “NPS” systems.

The primary NPS systems and methods for doing this herein are described in U.S. Pat. Nos. 10,064,013 and 9,693,195, the entire disclosures of which are herein incorporated by reference, and this type of detection system will be used throughout the examples of this disclosure. However, one of ordinary skill will understand that other systems and methods can be used to detect the presence of a human, or a particular human, to which the system can proactively initiate communication or action based on that presence. A key aspect of NPS systems of the type contemplated for use herein is their granularity. As discussed in the above referenced patent documents, an NPS system can detect an actual human, not a fiducial element that is used to proxy a human, although fiducial elements may be used in the system to augment the system's abilities or otherwise improve the system.

A further enhancement is that an NPS system may be able to differentiate the presence of multiple humans from the presence of a single human. In effect, an NPS system of use in the present systems and methods can know where any human is within its sensing area and if a human is or is not within the sensing area. Traditional systems based on “sensing” humans (e.g., motion detectors) are not able to do this as they cannot differentiate signals and simply can tell only if at least one human (or something thought to be human) is present.

Use of NPS systems can provide for substantial granularity in occupancy detection because they have the ability to not just detect presence of individuals in a relatively small area, but to track their movement within a large area. For example, NPS systems can be used to detect and predict a location of individuals within a large structure as contemplated, for example, in U.S. patent application Ser. No. 17/145,796 the entire disclosure of which is herein incorporated by reference. If individuals can be tracked individually within the residence, not only can usage changes be detected at a macro level, but usage changes can be detected for each individual user which can alter usage predictions depending on which users are present. Different types of users, for example, free-roaming household pets as compared to human users, can also be distinguished by such systems as indicated in, for example, U.S. patent application Ser. No. 17/894,634 the entire disclosure of which is herein incorporated by reference.

Thus, if a first user alters their typical showering time to much later which allows a second user to move their showering time earlier to overlap the first user's original time, the alteration of routine can be detected as two completely separate changes occurring in overlapping time windows instead of it being detected that a single event has simply moved within a time period. This can allow both better detection of accurate patterns, and better machine learning as patterns can be more readily associated with a specific user.

In addition to tracking individual usage, the ability to detect total numbers of users can also be very useful. NPS systems can detect total numbers of users as also contemplated in, for example, U.S. patent application Ser. No. 17/145,796 referenced above. In this case, a dramatic increase in the occupancy of a building will typically result in dramatically increased water usage. Thus, should the residents have guests over, their usage of water in the dwelling is not detected as anomalous usage compared to the regular occupant's normal behavior, but as anomalous usage which is to be expected based on the concurrent presence of anomalous higher occupancy. As such, a system presented with dramatically increased occupancy may provide much more restraint in comparing usage models or triggering alarms based on higher than typically expected usage. Similarly, machine learning systems may ignore such anomalous usage situations in their models treating such situations as presenting inaccurate data for learning normal usage behavior. This can result in those systems being trained both quicker and more accurately.

Finally, increased accuracy in detection of actual leak events (that is reductions of both false negatives and/or false positives) to a sufficient degree can also result in the leak detection systems being more safely provided with increased options of reactivity in response to a detected leak. If actual leak detection is sufficiently accurate, notifications of a user with an alert of a possible leak may be replaced by an actual shutdown of water in the affected area. This can not only make the system more autonomous, it can make it more effective.

Specifically, such systems being able to detect leaks quickly and shut off water to an affected area may be able to substantially reduce water damage from a leak, or even eliminate it entirely. However, incorrect automated responses where water is shut off while an occupant is using it can result in distrust of the system and the leak detection system being shut down. Thus, improved accuracy of leak detection through the inclusion of occupancy data will typically provide for a more robust and usable system. Finally, it should be recognized that while the present application focuses the discussion on embodiments that detect water leaks in a dwelling, the systems could be readily adapted and the methods readily used to detect any kind of fluid leak in any location or structure in alternative embodiments.

Further, it should be recognized that while the above disclosure is focused on the detection of water leaks and water discharge in a dwelling, the systems and methods discussed herein are useful for any type of structure and for any type of fluid. For example, the systems can be used in a factory or industrial setting to monitor for fluid chemical leaks. In such an embodiment, the occupancy information could be used both to assist in determining if the flow may be anomalous, and may be used as part of a safety response. For example, if a large flow was detected into an area of a plant which was occupied and the flow was anomalous because the amount was unexpectedly high, the system could trigger a quickly escalating alert to request confirmation from those present if the flow is anomalous and if the alert was not responded to (e.g. because personnel have been incapacitated), issue an alert to evacuate that portion of the plant while notifying emergency response personnel of a potential safety risk as well as providing information about which personnel that are in that portion of the plant.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “parallel” are purely geometric constructs and no real-world component or relationship is truly “parallel” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A method of inhibiting damage from fluid leaks in a structure, the method comprising:
providing a flow detection system which detects fluid flow into a at least a portion of the structure;
providing an occupancy detection system which detects that if said portion of said structure is occupied or not;
detecting a fluid flow in the portion of the structure;
determining if said fluid flow corresponds to an amount which is anomalous for that portion at a current time;
determining if said portion of the structure is currently occupied; and
if said portion of said structure is currently occupied, initiating a first level of alarm; and
if said portion of said structure is currently unoccupied, initiating a second level of alarm different from said first level or alarm.

2. The method of claim 1 wherein said first level of alarm comprises monitoring said amount of flow for further anomalies.

3. The method of claim 2 wherein said second level of alarm comprises an indicator to occupants of said structure.

4. The method of claim 2 wherein said second level of alarm comprises notifying a mobile device of said second level of alarm.

5. The method of claim 2 wherein said second level of alarm comprises said flow detection system shutting off said flow to said portion.

6. The method of claim 1 wherein said first level of alarm comprises an indicator to occupants of said structure.

7. The method of claim 6 wherein said second level of alarm comprises notifying a mobile device of said second level of alarm.

8. The method of claim 6 wherein said second level of alarm comprises said flow detection system shutting off said flow to said portion.

9. The method of claim 1 wherein said portion of said structure comprises a specific room in said structure.

10. The method of claim 1 wherein said at least a portion of said structure comprises the entirety of said structure.

11. The method of claim 1 wherein said detecting requires a level of flow above a predetermined threshold.

12. The method of claim 1 wherein said occupancy detection utilizes Network Presence Sensing (NPS) detection.

13. The method of claim 1 wherein said occupancy detection system detects and tracks a specific occupant within said structure.

14. The method of claim 1 wherein said occupancy detection system counts a number of occupants within said structure.

15. The method of claim 1 wherein said number of occupants is used to determine if said flow is anomalous.

16. The method of claim 1 wherein said occupancy detection system segregates human occupants from non-human occupants within said structure.

17. The method of claim 1 wherein said flow detection system utilizes machine learning in determining if said flow corresponds to said amount which is anomalous for that portion at said current time.

18. The method of claim 1 wherein machine learning is utilized in determining said first level of alarm and said second level of alarm after each anomalous flow detection.

19. The method of claim 1 wherein said detection system communicates with an automated fluid using system in determining if said flow corresponds to said amount which is anomalous for that portion at said current time.

20. The method of claim 1 wherein said fluid is water.
